(19) United States
(12) Patent Application Publication
(10) Pub. No.: US 2025/0146513 A1
(43) Pub. Date: May 8, 2025

(54) CAP BELLOWS ASSEMBLY AND ACCUMULATOR

(71) Applicant: NHK SPRING CO., LTD, Yokohama-shi (JP)

(72) Inventors: Naohito Nakano, Kanagawa (JP); Daijiro Ohta, Kanagawa (JP); Takashi Doi, Kanagawa (JP); Tomoya Kurokawa, Kanagawa (JP)

(73) Assignee: NHK SPRING CO., LTD, Yokohama-shi (JP)

(21) Appl. No.: 18/726,139

(22) PCT Filed: Jan. 20, 2023
(86) PCT No.: PCT/JP2023/001608

§ 371 Date: Jul. 2, 2024

(30) Foreign Application Priority Data
Jan. 31, 2022 (JP) 2022-013278

(51) Int. Cl. F15B 1/10

(52) U.S. Cl. CPC F15B 1/103

(57) ABSTRACT

A cap bellows assembly seals one end of a bellows provided inside an exterior body of an accumulator, the accumulator including a bottom, a shell, and a port, and includes: a cap body configured to cover an opening of the bellows; and a cap elastic portion provided between the cap body and the port and fixed to the cap body. A bonding surface of the cap body, to which the cap elastic portion is bonded, is subjected to a zinc calcium phosphate treatment, and a hopeite amount on the bonding surface is 4.8% or less.

### FIELD

The present invention relates to a cap bellows assembly and an accumulator.

### BACKGROUND

In an accumulator, a bellows has conventionally been used as a fluid separation membrane or a fluid sealing membrane having airtightness and stretchability. The bellows is provided in an internal space formed by a bottom, a shell, and a port. The cap bellows assembly is formed of a metal body that is connected (welded) to the bellows to seal the gas, and a rubber elastic portion that seals the oil between the bellows and the shell called a backup fluid. The elastic portion is required to have durability against a load applied during operation of the accumulator. As a technique for suppressing peeling of the elastic portion from the body, a technique for enhancing adhesion strength by performing zinc calcium phosphate treatment is known (see, for example, Patent Literature 1).

### CITATION LIST

### Patent Literature

Patent Literature 1: JP 2000-145804 A

### SUMMARY

### Technical Problem

However, zinc calcium phosphate treatment produces a relatively large crystal called hopeite (Zn₃(PO₄)₂·4H₂O). When stress concentrates on the hopeite at the bonded portion between the body and the elastic portion, the elastic portion may be peeled off from the body.

The present invention has been made in view of the above, and an object of the present invention is to provide a cap bellows assembly and an accumulator capable of improving durability of an elastic portion fixed to a body.

### Solution to Problem

To solve the above-described problem and achieve the object, a cap bellows assembly according to the present invention seals one end of a bellows provided inside an exterior body of an accumulator, the accumulator including a bottom, a shell, and includes: a cap body configured to cover an opening of the bellows; and a cap elastic portion provided between the cap body and the port and fixed to the cap body, wherein a bonding surface of the cap body, to which the cap elastic portion is bonded, is subjected to a zinc calcium phosphate treatment, and a hopeite amount on the bonding surface is 4.8% or less.

Moreover, in the above-described cap bellows assembly according to the present invention, the hopeite amount on the bonding surface is 3% or less.

Moreover, in the above-described cap bellows assembly according to the present invention, a number of times of durability against peeling of the cap elastic portion from the cap body in a durability test in which pressure is repeatedly applied while the pressure is varied in a range of 0 to 21 MPa is 10 million times or more.

Moreover, an accumulator according to the present invention includes: an exterior body including a bottom, a shell, and a port; a bellows provided inside the exterior body; and a cap bellows assembly configured to seal one end of the bellows, wherein the cap bellows assembly includes: a cap body configured to cover an opening of the bellows; and a cap elastic portion provided between the cap body and the port and fixed to the cap body, and a bonding surface of the cap body, to which the cap elastic portion is bonded, is subjected to a zinc calcium phosphate treatment, and a hopeite amount on the bonding surface is 4.8% or less.

Moreover, in the above-described accumulator according to the present invention, the hopeite amount on the bonding surface is 3% or less.

Moreover, in the above-described accumulator according to the present invention, the port includes a protrusion protruding toward the cap body, and a distance between the protrusion and the cap body is set according to an allowable deflection amount of the cap elastic portion.

### Advantageous Effects of Invention

According to the present invention, it is possible to improve the durability of the elastic portion fixed to the body in the cap bellows assembly.

### BRIEF DESCRIPTION OF DRAWINGS

FIG. 1 is a sectional view illustrating a configuration of an accumulator according to a first embodiment of the present invention.

FIG. 2 is a diagram illustrating a configuration of a cap of the accumulator illustrated in FIG. 1.

FIG. 3 is a diagram illustrating a relationship between the number of times of durability of an elastic portion and a hopeite amount.

FIG. 4 is a diagram illustrating a configuration in the vicinity of a cap of an accumulator according to a second embodiment of the present invention.

### DESCRIPTION OF EMBODIMENTS

Hereinafter, modes for carrying out the present invention (hereinafter, referred to as “embodiment”) will be described with reference to the accompanying drawings. The drawings are schematic, and the relationship between the thickness and the width of each portion, the ratio of the thickness of each portion, and the like may be different from actual ones, and portions having different dimensional relationships and ratios may be included between the drawings.

### First Embodiment

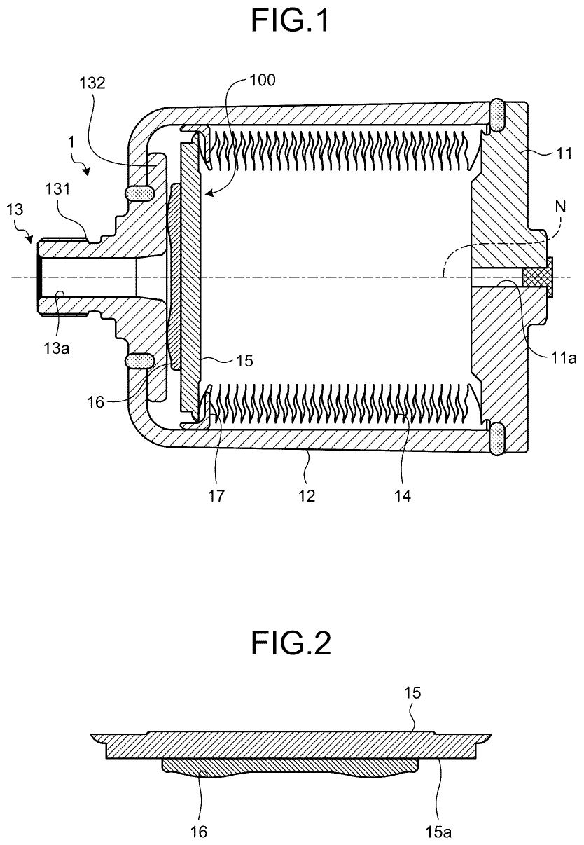

FIG. 1 is a sectional view illustrating a configuration of an accumulator according to a first embodiment of the present invention. An accumulator 1 illustrated in FIG. 1 includes a bottom 11, a shell 12, a port 13, a bellows 14 housed in an internal space formed by the bottom 11, the shell 12, and the port 13, a cap body 15, a cap elastic portion 16, and a guide bellows 17. The bottom 11, the shell 12, and the port 13 constitute an exterior body of the accumulator 1. The cap body 15 and the cap elastic portion 16 constitute a cap bellows assembly 100.

Here, the bottom 11 and the port 13 are formed by using, for example, a cold-working material. The shell 12 is formed by using a hot-working material, for example.

In the accumulator 1, the space formed by the bottom 11, the shell 12, and the port 13 is divided by the bellows 14. Specifically, different spaces are formed between the outside and the inside of the bellows 14. The internal space of the bellows 14 communicates with the outside via a hole 11a of the bottom 11. The space outside the bellows 14 communicates with the outside via a hole 13a of the port 13. FIG. 1 illustrates an example in which the central axes of the holes 11a and 13a coincide with the central axis N of the accumulator 1.

The bottom 11, the shell 12, and the port 13 are welded and fixed at respective connection portions.

In the accumulator 1, a liquid (hydraulic oil) or a gas (for example, nitrogen gas) is sealed in each of a space (bellows external space) formed by the exterior body and the bellows 14 and the internal space of the bellows 14. For example, a liquid is introduced into the bellows external space, and a gas is enclosed in the internal space.

The port 13 extends in a tubular shape and includes an introduction portion 131 which is an introduction port of a liquid into the shell 12, and a locking portion 132 which is connected to one end of the introduction portion 131 and is locked to an inner wall surface of the shell 12.

The bellows 14 has a tubular shape. A side surface portion of the bellows 14 has an accordion shape formed by repeating an uneven shape, and it extends and contracts with an external load. In the bellows 14, the gap between the shell 12 and the bellows 14 is maintained by a guide bellows 17 provided on the outer peripheral side, and the bellows can smoothly extend and contract. The bellows 14 is formed by using, for example, stainless steel (SUS304). The guide bellows 17 is formed by using polybutylene terephthalate (PBT) or polyamide, for example.

The cap body 15 has a plate shape and covers an opening of the bellows 14 on a side opposite to the bottom 11 side, and an end portion of the bellows 14 is welded to seal the opening. The cap body 15 is constituted by using a material having durability to a pressure state (low pressure or high pressure) in the accumulator 1. The cap body 15 is formed by using, for example, metal, specifically, a steel plate hot commercial (SPHC). The cap body 15 preferably has heat resistance according to a use state.

The cap elastic portion 16 has a plate shape and is provided on the side of the cap body 15 opposite to the bellows 14 side. The cap elastic portion 16 is positioned between the port 13 and the cap body 15, and it seals the liquid (hydraulic oil) between the shell 12 and the bellows 14. The cap elastic portion 16 is formed by using, for example, acrylonitrile butadiene rubber (NBR).

The cap body 15 and the cap elastic portion 16 are formed by performing surface treatment by subjecting the bonding surface of the cap body 15 to phosphoric acid treatment, and then bonding the cap elastic portion 16 to the cap body 15 by applying an adhesive or the like to the bonding surface. In the first embodiment, zinc calcium phosphate treatment is performed as the phosphoric acid treatment.

For example, when the bonding surface of the cap body 15 is subjected to zinc calcium phosphate, a relatively large crystal called hopeite (Zn₃(PO₄)₂·4H₂O) is produced. The hopeite is a crystal having a relatively large size in which stress concentration occurs when stress is applied. In the first embodiment, durability against repeated use of the accumulator 1 is imparted by defining the amount of the hopeite.

In the first embodiment, the hopeite amount after the surface treatment on the cap body 15 is 4.8% or less. It is preferably 3% or less from the viewpoint of obtaining reliable durability. The hopeite amount corresponds to the amount of hopeite on the bonding surface of the cap elastic portion 16 of the cap body 15. As a method for calculating the hopeite amount, for example, first, a part of the bonding surface is observed with a scanning electron microscope (SEM), and a crystal having a larger size than other crystals is extracted as hopeite from an obtained SEM image. Thereafter, the existence ratio of the extracted hopeite is calculated, and the hopeite amount is determined as a value obtained by converting this existence ratio into the bonding area. For the extraction of hopeite, an observer may specify the hopeite, of the image processing (for example, contour extraction) may be performed to extract the hopeite.

In the accumulator 1, when the pressure of the line connected to the accumulator 1 changes through supplying/sucking the liquid via the hole 13a of the port 13, the fluid flows in from the hole 13a of the port 13, and the cap bellows assembly 100 is pushed up. The pressure in the space between the bellows 14 and the shell 12 is always the same as the pressure inside the bellows 14.

When the pressure (hydraulic pressure) of the line is 0, the load applied to the cap elastic portion 16 becomes the largest. At this time, the sealing pressure of the accumulator 1 is applied to the cap elastic portion 16. In a case where the hydraulic oil flows in from the hole 13a due to an increase in the hydraulic pressure of the line, the bellows 14 contracts when the hydraulic oil reaches a pressure equal to or higher than the sealing pressure of the accumulator 1. When the hydraulic pressure of the line decreases and the bellows 14 extends (returns) from the contracted state, the hydraulic oil is discharged from the hole 13a to the outside. The pressurized state with the accumulator 1 is controlled by the discharge of the liquid from the hole 13a. In addition, due to repeated use of the accumulator 1, a load is applied to the cap elastic portion 16.

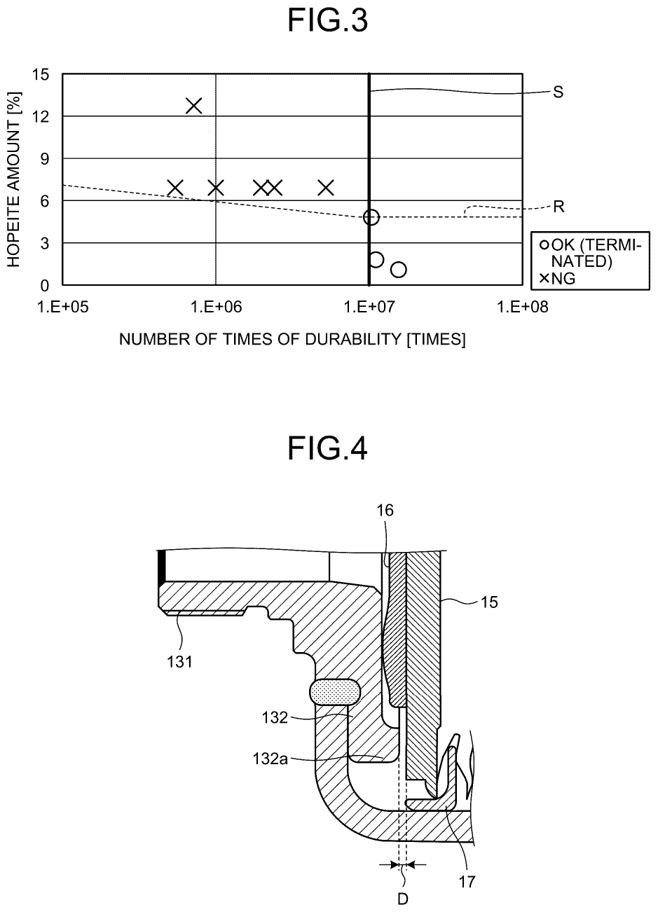

As an example, the results of a peeling durability test with a test piece in which the cap elastic portion 16 is attached to the cap body 15 are shown in Table 1. In the peeling durability test, the number of times of durability until the cap elastic portion 16 peeled off from the cap body 15 or until the number of times of durability exceeded a predetermined number (10 million times as the number of times of repetition this time) was measured in a case where the sealing pressure of the accumulator 1 was set to 13 MPa, the test temperature was set to 80° C., the test pressure applied to the bellows 14 was varied at 0 to 21 MPa, and the accumulator 1 was repeatedly stopped and operated to receive stress. FIG. 3 is a diagram illustrating a relationship between the number of times of durability of the elastic portion and the hopeite amount in the test piece shown in Table 1. In the peeling durability test, when the number of repetitions (number of times of durability) exceeds 10 million (the reference line S in FIG. 3), the test was terminated even when the cap elastic portion 16 was not peeled off from the cap body 15.

TABLE 1

| | Hopeite amount | Number of times | |
|---|---|---|---|
| Test piece No. | (%) | of durability | Durability result |
| 1 | 1.1 | 15,500,000 | OK (Terminated) |
| 2 | 1.8 | 11,100,723 | OK (Terminated) |
| 3 | 1.8 | 11,100,723 | OK (Terminated) |
| 4 | 4.8 | 10,360,585 | OK (Terminated) |
| 5 | 6.9 | 5,211,016 | NG |
| 6 | 6.9 | 2,413,460 | NG |
| 7 | 6.9 | 1,978,740 | NG |
| 8 | 6.9 | 1,000,000 | NG |
| 9 | 6.9 | 1,000,000 | NG |
| 10 | 6.9 | 543,290 | NG |
| 11 | 12.7 | 723,505 | NG |

As shown in Table 1 and FIG. 3, when the hopeite amount is 4.8% or less, durability of 10 million times or more is achieved. On the other hand, it can be seen that when the hopeite amount is large (6.9% and 12.7% here), the number of times of durability does not reach 10 million times, and the durability is not satisfied. From these results, it can be said that the durability of 10 million times is satisfied when the hopeite amount is 4.8% or less. In addition, from the obtained results, for example, it is possible to generate a boundary line R (see FIG. 3) that defines an upper limit value of the hopeite amount satisfying the durability with respect to a predetermined number of times of durability in the relationship between the number of times of durability and the hopeite amount.

According to the first embodiment, the durability of the cap elastic portion 16 fixed to the cap body 15 can be improved by regulating the hopeite amount on the bonding surface of the cap body 15. In particular, by applying the cap bellows assembly 100 according to the first embodiment to an accumulator of a relatively high pressure sealed type as the type of the accumulator 1, an accumulator having excellent durability can be obtained.

### Second Embodiment

Next, a second embodiment of the present invention will be described with reference to FIG. 4. FIG. 4 is a diagram illustrating a configuration in the vicinity of a cap of an accumulator according to the second embodiment of the present invention. The same portions as those of the accumulator 1 according to the first embodiment are denoted by the same reference numerals. An example in which the accumulator according to the second embodiment regulates the distance between the port 13 and the cap body 15 with the cap elastic portion 16 will be described. The hopeite amount in the cap body 15 is the same as that in the first embodiment.

FIG. 4 illustrates a state in which the locking portion 132 of the port 13 and the cap elastic portion 16 are in contact with each other and the locking portion 132 does not apply a load to the cap elastic portion 16. In the second embodiment, the locking portion 132 includes a protrusion 132a protruding toward the cap body 15. In FIG. 4, the cap elastic portion 16 is in a natural state in which the cap elastic portion is not crushed by the load from the locking portion 132 and no load from the outside is applied other than gravity. In this natural state, the distance D between the port 13 and the cap body 15 is set according to the allowable deflection amount of the cap elastic portion 16 under the most severe use condition assumed. In the first embodiment, the distance D is a distance between the tip of the protrusion 132a and the cap body 15. That is, by setting the distance D, the load applied to the cap elastic portion 16 under the most severe use condition is limited.

According to the second embodiment, as in the first embodiment, the durability of the cap elastic portion 16 fixed to the cap body 15 can be improved by regulating the hopeite amount on the bonding surface of the cap body 15.

Further, in the second embodiment, defining the distance D between the port 13 and the cap body 15 in the natural state and bringing the port 13 and the cap body 15 into contact with each other according to the applied load makes it possible to suppress the load applied to the cap elastic portion 16. According to the second embodiment, since the crushing of the cap elastic portion 16 is suppressed because the protrusion 132a and the cap body 15 are in contact with each other, the peeling of the cap elastic portion 16 from the cap body 15 can be more reliably suppressed.

Although an embodiment for carrying out the present invention have been described so far, the present invention should not be limited only by the above-described embodiment.

As described here, the present invention can include various embodiments and the like not described herein, and various design changes and the like can be made without departing from the technical idea specified by the claims.

### INDUSTRIAL APPLICABILITY

As described above, the cap bellows assembly and the accumulator according to the present invention are suitable for improving the durability of the elastic portion fixed to the body in the cap bellows assembly.

### REFERENCE SIGNS LIST

1 ACCUMULATOR
11 BOTTOM
12 SHELL
13 PORT
14 BELLOWS
15 CAP BODY
16 CAP ELASTIC PORTION
17 GUIDE BELLOWS
100 CAP BELLOWS ASSEMBLY

1. A cap bellows assembly for sealing one end of a bellows provided inside an exterior body of an accumulator, the accumulator including a bottom, a shell, and a port, the cap bellows assembly comprising:
a cap body configured to cover an opening of the bellows; and
a cap elastic portion provided between the cap body and the port and fixed to the cap body, wherein
a bonding surface of the cap body, to which the cap elastic portion is bonded, is subjected to a zinc calcium phosphate treatment, and
a hopeite amount on the bonding surface is 4.8% or less.

2. The cap bellows assembly according to claim 1, wherein the hopeite amount on the bonding surface is 3% or less.

3. The cap bellows assembly according to claim 1, wherein a number of times of durability against peeling of the cap elastic portion from the cap body in a durability test in which pressure is repeatedly applied while the pressure is varied in a range of 0 to 21 MPa is 10 million times or more.

4. An accumulator comprising:
an exterior body including a bottom, a shell, and a port;
a bellows provided inside the exterior body; and
a cap bellows assembly configured to seal one end of the bellows, wherein
the cap bellows assembly includes:
a cap body configured to cover an opening of the bellows; and
a cap elastic portion provided between the cap body and the port and fixed to the cap body, and
a bonding surface of the cap body, to which the cap elastic portion is bonded, is subjected to a zinc calcium phosphate treatment, and
a hopeite amount on the bonding surface is 4.8% or less.

5. The accumulator according to claim 4, wherein the hopeite amount on the bonding surface is 3% or less.

6. The accumulator according to claim 4 or 5, wherein
the port includes a protrusion protruding toward the cap body, and
a distance between the protrusion and the cap body is set according to an allowable deflection amount of the cap elastic portion.

7. The accumulator according to claim 5, wherein
the port includes a protrusion protruding toward the cap body, and
a distance between the protrusion and the cap body is set according to an allowable deflection amount of the cap elastic portion.
